(19) United States
(12) Patent Application Publication
(10) Pub. No.: US 2021/0333646 A1
(43) Pub. Date: Oct. 28, 2021

(54) DISPLAY PANEL AND MANUFACTURING METHOD OF DISPLAY PANEL

(71) Applicant: Shenzhen China Star Optoelectronics Semiconductor Display Technology Co., Ltd., Shenzhen, Guangdong (CN)

(72) Inventor: Wu Cao, Shenzhen (CN)

(21) Appl. No.: 16/626,729

(22) PCT Filed: Dec. 20, 2019
(86) PCT No.: PCT/CN2019/126850

§ 371 Date: Dec. 26, 2019

(30) Foreign Application Priority Data
Dec. 13, 2019 (CN) 201911280318.9

(51) Int. Cl. G02F 1/1337; G02F 1/1339

(52) U.S. Cl. CPC G02F 1/133788; G02F 1/1339

(57) ABSTRACT

The present disclosure provides a display panel and a manufacturing method of the display panel. The manufacturing method includes: providing a substrate for coating an alignment film; providing a mask, exposing the substrate through the mask, and defining a hydrophilic region and a hydrophobic region on a surface of the substrate; coating the alignment film on the substrate in the hydrophilic region to limit the alignment film in the hydrophilic region to control an accuracy of alignment film border to prevent light leakage or uneven brightness of the display panel, or stability failure in the reliability test.

### FIELD OF INVENTION

The present disclosure relates to the field of display panel manufacture, more particularly to a display panel and a manufacturing method of the display panel.

### BACKGROUND OF INVENTION

Black matrix on array (BOA) technology and color filter on array (COA) technology are two common integrated technologies applied to liquid crystal displays (LCDs).

Black photo spacer (BPS) technology, as a type of BOA technology, is often used in conjunction with COA technology to manufacture display panels. During the manufacturing processes, the two independent processes of manufacturing black matrixes and manufacturing spacers in the LCD devices are integrated into one fabrication which can achieve manufacturing processes of three structural functions. That is, the black organic photoresists on an array substrate are utilized to obtain different heights of main spacers, sub spacers, and black matrixes in a single exposure development manufacturing process. As a result, the function of supporting the thickness of the box can be achieved while achieving light blocking.

In common structures of black matrixes on color filter (BMs on CF), the BMs on CF forms alignment marks by patter technology to enhance accuracy of each stage of manufacturing processes. However, in BPS technology, which is different from BM on CF, black matrixes are disposed on array substrate.

More particularly, in the box-manufacturing process, because BPS does not involve a pattern process, it is impossible to control the accuracy of polyimide (PI) alignment film spraying. The accuracy of PI alignment film spraying will affect the display performance. When the sprayed PI alignment film cannot completely cover the display region of the display device, it will cause light leakage. In addition, if the PI alignment film is stacked on the border of the display region, problems of uneven brightness will occur. If the PI alignment film exceeds the application range, that is, the cutting line is exceeded, the PI alignment is sprayed to portions such as the via region, there is a risk of stability failure in reliability testing due to the adhesive effect between the PI alignment film and the frame adhesive along with water vapor impact in a long period.

### Technology Problems

The preset disclosure provides a display panel and a manufacturing method of the display panel to solve light leakage or brightness uneven of display panels resulted from inaccuracy of alignment film border due to lacking of alignment marks on the base substrate during manufacturing processes in the existing display panel.

### SUMMARY OF INVENTION

First, the present disclosure provides a manufacturing method of a display panel comprising the following steps.

Step S10: providing a substrate for coating an alignment film.

Step S20: providing a mask, exposing the substrate through the mask, and defining a hydrophilic region and a hydrophobic region on a surface of the substrate, wherein the hydrophilic region corresponds to a display region of the display panel and the hydrophobic region corresponds to a non-display region of the display panel.

Step S30: coating the alignment film on the substrate in the hydrophilic region.

In the manufacturing method, the mask comprises a transparent region and a light shield region, and the transparent region corresponds to the display region and the light shield region corresponds to the non-display region in the step S20.

In the manufacturing method, the substrate is exposed through an ultraviolet in the step S20.

In the manufacturing method, the substrate is exposed through an extreme ultraviolet in the step S20.

In the manufacturing method, the substrate for coating the alignment film is washed before the step S20 is implemented.

In the manufacturing method, the substrate comprises a base substrate and a conductive layer, the conductive layer is formed on a surface of the base substrate in both of the display region and the non-display region, and the alignment film is formed on a surface of the conductive layer away from the base substrate.

In the manufacturing method, a material of the conductive layer is one of indium tin oxide, indium tin oxide, or zinc oxide.

In the manufacturing method, the display panel further comprises a sealant region in the non-display region, and a boundary of the hydrophilic region and the hydrophobic region in the non-display region and on a side of the sealant region close to the display region.

In the manufacturing method, the step S30 further comprises:

Step S301: coating an alignment film solution on the surface of the substrate; and

Step S302: obtain the alignment film by curing the alignment film solution.

In the manufacturing method, in the step S301, a contacting angle of the alignment film solution in the hydrophobic region is greater than a contacting angle of the alignment film solution in the hydrophilic region.

In the manufacturing method, a difference between the contacting angle of the alignment film solution in the hydrophobic region and the contacting angle of the alignment film solution in the hydrophilic region is equal to or large than 15° and less than or equal to 180°.

In the manufacturing method, a contacting angle of the alignment film solution in the hydrophilic region is greater than or equal to 0° and less than 90°.

In the manufacturing method, the contacting angle of the alignment film solution in the hydrophilic region is greater than or equal to 0° and less than or equal to 30°.

In the manufacturing method, a material of the alignment film solution is Polyimide.

In the manufacturing method, the mask is a hard patterned substrate or a soft patterned substrate.

In the manufacturing method, the mask is a hard patterned substrate or a soft patterned substrate.

Second, the present disclosure the present disclosure further provides a display panel manufactured by the manufacturing method of the display panel above.

In the display panel, the display panel further comprises an array substrate comprising a pair of alignment marks, and a surface of the array substrate having the pair of alignment marks provides with a first alignment film.

Beneficial Effects

In contrast to the prior art, the present disclosure provides a manufacturing method of a display panel. The manufacturing method includes: providing a substrate for coating an alignment film; providing a mask, exposing the substrate through the mask, and defining a hydrophilic region and a hydrophobic region on a surface of the substrate, wherein the hydrophilic region corresponds to a display region of the display panel and the hydrophobic region corresponds to a non-display region of the display panel; and coating the alignment film on the substrate in the hydrophilic region.

The present disclosure provides a display panel and a manufacturing method of the display panel. The manufacturing method includes: providing a substrate for coating an alignment film; providing a mask, exposing the substrate through the mask, and defining a hydrophilic region and a hydrophobic region on a surface of the substrate; coating the alignment film on the substrate in the hydrophilic region to limit the alignment film in the hydrophilic region. By adopting the present invention, the existing display panel manufacturing method can solve the problem that the alignment accuracy of the alignment film cannot be controlled because there is no alignment mark on the substrate, can solve the problem that the coverage area of the alignment film is insufficient or excess regions should be coated, and can solve the problem of light leakage or uneven brightness of the display panel. Thus, the present disclosure can solve the problem of stability failure in the reliability test caused by adhesive between the alignment film and the frame adhesive and prevents errors resulted from lacking to alignment marks by using edge information of the substrate as a reference mark. The present disclosure can control the accuracy of the boundary of the alignment film without increasing the difficulty and of the existing manufacturing processes.

### DESCRIPTION OF DRAWINGS

FIG. 1A illustrates a flow chart of a manufacturing method of a display panel of an embodiment of the present disclosure.

FIG. 1B-AE illustrate diagrams of the manufacturing method shown in FIG. 1A.

FIG. 2 illustrates a structural diagram of a substrate provided by the embodiment of the present disclosure.

FIG. 3 illustrates a top view of the display panel provided by the embodiment of the present disclosure.

FIG. 4 illustrates a structural diagram of a mask provided by the embodiment of the present disclosure.

### DETAILED DESCRIPTION OF PREFERRED EMBODIMENTS

In order to clarify the technical solutions of embodiments of the present disclosure, the present disclosure is described by the embodiments in detail accompany with drawings. Obviously, the mentioned embodiments are utilized to clarify the present discloser rather than limit the present disclosure.

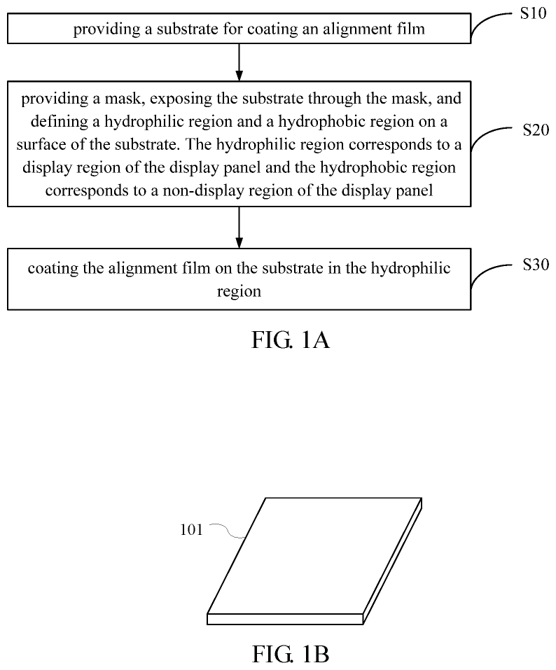

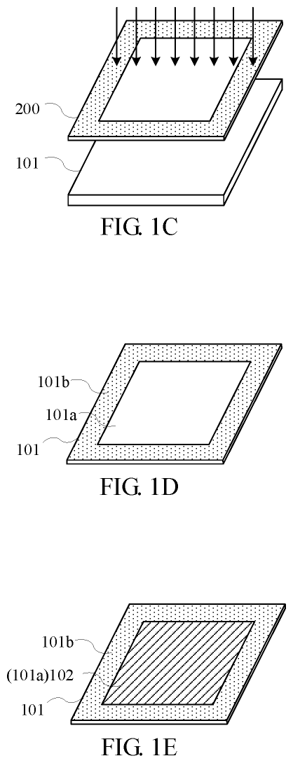

More particularly, please refer to FIG. 1A which illustrates a flow chart of a manufacturing method of a display panel of an embodiment of the present disclosure. The corresponding processes of the manufacturing method include the following steps as shown in FIG. 1B-1D.

Step S10: providing a substrate 101 for coating an alignment film.

Step S20: providing a mask 200, exposing the substrate 101 through the mask 200, and defining a hydrophilic region 101a and a hydrophobic region 101b on a surface of the substrate. The hydrophilic region 101a corresponds to a display region of the display panel and the hydrophobic 101b region corresponds to a non-display region of the display panel as shown in FIG. 1C and FIG. 1D.

Step S30: coating the alignment film 102 on the substrate 101 in the hydrophilic region 101a, as shown in FIG. 1E, to prevent the display panel from light leakage or uneven brightness resulting from insufficient or excess coverage of the alignment film 102.

The substrate 101 for coating the alignment film is washed before the step S20 is implemented.

The substrate 101 is exposed using ultraviolet (UV) photolithography in the step S20. The UV photolithography includes an extreme ultraviolet lithography (EUV) photolithography.

The step S30 further includes the following steps.

Step S301: coating an alignment film solution on the surface of the substrate 101.

Step S302: obtain the alignment film 102 by curing the alignment film solution.

A material of the alignment film solution is polyimide.

The alignment film solution can be coated in the hydrophilic region 101a by a spraying method, a spin coating method, or a liquid phase method. Due to the diffusing tendency of the alignment film solution, at the boundary between the hydrophilic region 101a and the hydrophobic region 101b, the alignment film solution will be easier to be coated in the hydrophilic region 101a, and the alignment film solution will be coated on expected coating boundary is obtained at the boundary between the hydrophilic region 101a and the hydrophobic region 101b, so that the accuracy of the boundary is under control.

When measuring the wetting performance of a liquid on a material surface, the contacting angle of the liquid on the surface of a solid material is generally used for illustrating characterization. Thus, the performance of the alignment film solution in the hydrophilic region 101a and in the hydrophobic region 101b can also be measured by contacting angles for illustrating characterization.

Because the hydrophilic region 101a and the hydrophobic region 101b have different hydrophilic properties, the alignment film solution has different contacting angles in the hydrophobic region 101b and the hydrophilic region 101a. In order to make the alignment film solution forms the alignment film 102 with sufficient boundary accuracy, in step S301, the contacting angle θ1 of the alignment film solution in the hydrophobic region 101b is greater than the contacting angles θ2 of the alignment film solution in the hydrophilic region 101a, thereby the hydrophilic region 101a has better wetting performance, and the alignment film solution diffuses better in the hydrophilic region 101a.

In addition because the greater difference between the contacting angle θ1 of the alignment film solution in the hydrophobic region 101b and the contacting angle θ2 of the alignment film solution in the hydrophilic region 101a, the more different of diffusion performance of the alignment film solution in the hydrophilic region 101a and the hydrophobic region 101b is. The difference between the contacting angle θ1 of the alignment film solution in the hydrophobic region 101b and the contacting angle θ2 of the alignment film solution in the hydrophilic region 101a is greater than or equal to 15° and less than or equal to 180°. That is, 15°≤θ1-θ2≤180°, to ensure sufficiently different wetting performances of the hydrophilic region 101a and the hydrophobic region 101b to ensure that the boundary of the alignment film 102 has sufficient accuracy.

90° is the key point of the contacting angle whether the alignment film solution can wet the hydrophilic region 101a or not. Therefore, to ensure that the alignment film solution can be coated in the hydrophilic region 101a and the coated alignment film 102 has sufficient boundary accuracy, and the contact angle θ2 of the alignment film solution in the hydrophilic region 101a is less than 90°. Similarly, the contact angle θ2 of the alignment film solution in the hydrophilic region 101a is greater than or equal to 0°. When the contact angle θ2 of the alignment film solution in the hydrophilic region 101a is equal to 0°, the alignment film solution can be completely coated in the hydrophilic region 101a. Therefore, the variation range of the contact angle θ2 of the alignment film solution in the hydrophilic region 101a is: 0°≤θ2≤90°. Furthermore, the variation range the contact angle θ2 of the alignment film solution in the hydrophilic region 101a is: 0°≤θ2≤90°.

The step of washing the substrate for coating the alignment film before the step S20, the step S20, and the step S30 are implemented in an before process cleaning (BPC) machine.

The BPC machine includes stations having pure water or chemical reagent cleaning parts, drying and EUV processing parts, and film-forming curing parts. Each part of the BPC machine corresponds to each station, so washing the substrate for coating the alignment film can be performed at a washing station. The step S20 may be performed at an UV or EUV station, and the step S30 may be performed at a film formation curing station. As a result, the processes can be greatly saved and the accuracy of the boundary of the alignment film 102 is improved while keeping or slightly change the existing manufacturing processes.

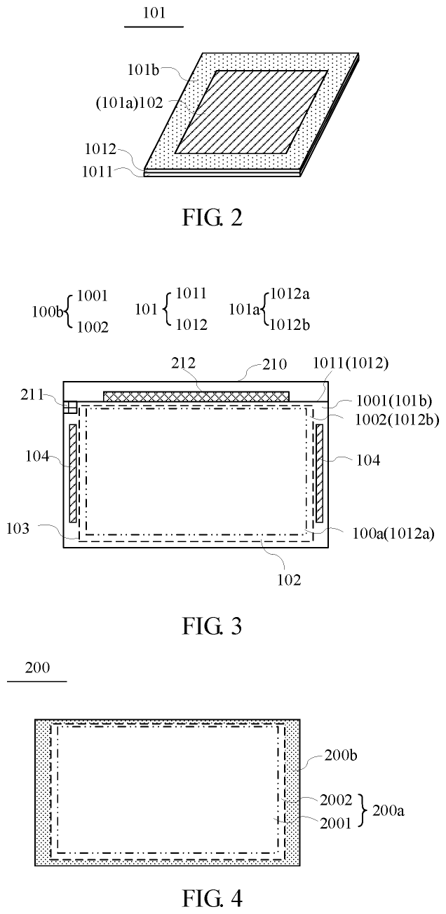

Please refer to FIG. 2 which illustrates a structural diagram of the substrate of the embodiment of the present disclosure. The substrate 101 includes a base substrate 1011 and a conductive layer 1012. The conductive layer 1012 is disposed on a surface of the base substrate 1011 and is located in the display region and the non-display region. The alignment film 102 is formed on a surface of the conductive layer 1012 facing away from the base substrate 1011.

The hydrophilic region 101a and the hydrophobic region 101b are formed on a surface of the conductive layer 1012 facing away from the base substrate 1011 by the ultraviolet photolithography technology.

The material of the conductive layer 1012 includes one of indium tin oxide, indium tin oxide, and zinc oxide.

The present application also provides a display panel manufactured by the manufacturing method of the display panel. More particularly, please refer to FIG. 3 which is a top view of the display panel provided by an embodiment of the present application. The display panel has at least one display region 100a and a non-display region 100b located on the periphery of the display region 100a. The non-display region 100b includes a first non-display region 1001 and a second non-display region 1002. The second non-display region 1002 is located between the display region 100a and the first non-display region 1001.

The display panel further includes a frame region (not shown) located in the non-display region 100b A boundary 103 between the hydrophilic region 101a and the hydrophobic region 101b is located in the non-display region 100b, and located in one side of frame region close to the display region 100a. More particularly, the boundary 103 between the hydrophilic region 101a and the hydrophobic region 101b is located on one side of the GOA wires 104 close to the display region 100a.

The substrate 101 is a color film substrate. The display panel further includes an array substrate 210 disposed opposite to the substrate 101. The array substrate 210 includes a first alignment film, a first conductive layer, a first insulating layer, and a color resist layer, a second insulating layer, a gate insulating layers, gate signal lines, data signal lines, etc. not shown in drawings. A pair of alignment marks 211 is provided on the array substrate 210. The alignment marks 211 are configured to form the first alignment film on one side of the array substrate 210 close to the substrate 101. A binding terminal 212 is disposed on the non-display region of the of the array substrate 210 of the display panel. The binding terminal 212 is not covered by the substrate 101.

Please refer to FIG. 4 which is a structural diagram of a mask provided in the embodiment of the present disclosure. The mask 200 includes a transparent region 200a and a light shield region 200b. In step S20, the transparent region 200a is aligned with the display region, and the light shield region 200b is aligned with the non-display region.

The transparent region 200a includes a first transparent region 2001 and a second transparent region 2002 located outside the first transparent region 2001. In step S20, the first transparent region 2001 is aligned with the display region, the second transparent region 2002 is aligned with the second non-display region, and the light shield region 200b is aligned with the non-display region, so that a boundary between the hydrophilic region and the hydrophobic region is located in the non-display region. Thus, the problem of light leakage of the display panel caused by insufficient coverage of the alignment film can be prevented.

More particularly, please refer to FIG. 3 and FIG. 4, when the mask 200 is disposed on the surface of the conductive layer 1012, the first transparent region 2001 is aligned with the display region 100a, the second transparent region 2002 is aligned with the second non-display region 1002. EUV lithography technology is applied on the surface of the conductive layer 1012 which covers the mask 200. Oxygen ions on the conductive layer 1012 are stimulated. An oxidation reaction activates the surface and forms a surface that is hydrophilic to the surface. The surface is activated to form hydrophilic functional groups that are favorable for surface bonding, and the bonding property of the surface of the conductive layer 1012 is changed, so that the hydrophilic region 101a and the hydrophobic region 101b can be formed on the surface of the conductive layer 1012.

The hydrophilic region 101a includes a first hydrophilic region 1012a and a second hydrophilic region 1012b. More particularly, the conductive layer 1012 is exposed though the first transparent region 2001 of the mask 200 so that the first hydrophilic region 1012a is formed on the surface of the conductive layer 1012. The conductive layer 1012 is exposed through the second transparent region 2002 of the mask 200 to form the second hydrophilic region 1012b on the surface of the conductive layer 1012 in order to make the boundary 103 of the hydrophilic region 101a and the hydrophobic region 101b fall within the non-display region 100b, Thus, the problem of light leakage of the display panel caused by insufficient coverage of the alignment film 102 is prevented.

EUV lithography uses a shorter wavelength of the light source and a shorter exposure wavelength, thus the lithographic resolution also higher and the feature size performance of products is more accurate. The conductive layer 1012 exposed by EUV lithography can obtain the finer boundary between the obtained hydrophilic region 101a and the hydrophobic region 101b. Because the alignment film 102 is limited in the hydrophilic region 101a, the boundaries of the alignment film 102 are also finer, so accuracy control of the alignment film 102 boundaries can be achieved.

The mask 200 is a hard patterned substrate or a soft patterned substrate, and includes a glass substrate plated with a metal pattern, a metal sheet with a mesh, and a film.

The present disclosure provides a display panel and a manufacturing method of the display panel. The manufacturing method includes: providing a substrate 101 for coating an alignment film; providing a mask 200, exposing the substrate 101 through the mask 200, and defining a hydrophilic region 101a and a hydrophobic region 101b on a surface of the substrate where the hydrophilic region 101a corresponds to a display region of the display panel and the hydrophobic 101b region corresponds to a non-display region of the display panel; coating the alignment film 102 on the substrate 101 in the hydrophilic region 101a to limit the alignment film 102 in the hydrophilic region 101a. By adopting the present disclosure, the problem existing in manufacturing method of the display panels can be solved. The problem existing in manufacturing method is that the alignment boundary of the alignment film 102 cannot be restricted due to lack of alignment mark on the substrate 101, thereby light leakage or uneven brightness of the display panel occur due to insufficient coverage area. As a result, the problems of stability failure in the reliability test of adhesive between the alignment film 102 and the frame adhesive are prevented, and problems of errors of the alignment film 102 resulted from lacking alignment marks are prevented by adopting the edge information of the substrate 101 as a reference mark. The present disclosure can control the accuracy of the boundary of the alignment film without increasing the difficulty and time of the existing manufacturing processes.

In the above embodiments, the description of each embodiment has its own emphasis. For parts that are not described in detail in one embodiment may refer to descriptions in other embodiments.

The display panel and the manufacturing method of the display panel provided in the embodiments of the present disclosure have been described in detail above. The aspects and implementations of the present application are explained by using specific examples. The descriptions of the above embodiments are only used to clarify the technical solutions and core ideas of the present disclosure. A skilled person in the art should understand that modifications, equivalent, or replacement of some technical feature can be obtained according to the technical solutions described in the foregoing embodiments. These modifications or replacements fall in the scope of the technical solutions of each embodiment of the present disclosure.

What is claimed is:

1. A manufacturing method of a display panel, comprising:
step S10: providing a substrate for coating an alignment film;
step S20: providing a mask, exposing the substrate through the mask, and defining a hydrophilic region and a hydrophobic region on a surface of the substrate, wherein the hydrophilic region corresponds to a display region of the display panel and the hydrophobic region corresponds to a non-display region of the display panel; and
step S30: coating the alignment film on the substrate in the hydrophilic region.

2. The manufacturing method according to claim 1, wherein the mask comprises a transparent region and a light shield region, and the transparent region corresponds to the display region and the light shield region corresponds to the non-display region in the step S20.

3. The manufacturing method according to claim 1, wherein the substrate is exposed using an ultraviolet in the step S20.

4. The manufacturing method according to claim 3, wherein the substrate is exposed using an extreme ultraviolet in the step S20.

5. The manufacturing method according to claim 1, wherein the substrate for coating the alignment film is washed before the step S20 is implemented.

6. The manufacturing method according to claim 1, wherein the substrate comprises a base substrate and a conductive layer, the conductive layer is formed on a surface of the base substrate in both of the display region and the non-display region, and the alignment film is formed on a surface of the conductive layer away from the base substrate.

7. The manufacturing method according to claim 6, wherein a material of the conductive layer is one of indium tin oxide, indium tin oxide, or zinc oxide.

8. The manufacturing method according to claim 1, wherein the display panel further comprises a sealant region in the non-display region, and a boundary of the hydrophilic region and the hydrophobic region in the non-display region and on a side of the sealant region close to the display region.

9. The manufacturing method according to claim 1, wherein the step S30 further comprises:
step S301: coating an alignment film solution on the surface of the substrate; and
step S302: obtain the alignment film by curing the alignment film solution.

10. The manufacturing method according to claim 9, wherein in the step S301, a contacting angle of the alignment film solution in the hydrophobic region is greater than a contacting angle of the alignment film solution in the hydrophilic region.

11. The manufacturing method according to claim 10, wherein a difference between the contacting angle of the alignment film solution in the hydrophobic region and the contacting angle of the alignment film solution in the hydrophilic region is equal to or greater than 15° and less than or equal to 180°.

12. The manufacturing method according to claim 9, wherein a contacting angle of the alignment film solution in the hydrophilic region is greater than or equal to 0° and less than 90°.

13. The manufacturing method according to claim 12, wherein the contacting angle of the alignment film solution in the hydrophilic region is greater than or equal to 0° and less than or equal to 30°.

14. The manufacturing method according to claim 9, wherein a material of the alignment film solution is Polyimide.

15. The manufacturing method according to claim 1, wherein the mask is a hard patterned substrate or a soft patterned substrate.

16. A display panel manufactured by the manufacturing method of the display panel according to claim 1.

17. The display panel according to claim 16, wherein the display panel further comprises an array substrate comprising a pair of alignment marks, and a surface of the array substrate having the pair of alignment marks provides with a first alignment film.
